(19) United States
(12) Patent Application Publication
(10) Pub. No.: US 2026/0109229 A1
(43) Pub. Date: Apr. 23, 2026

(54) DISPLAY CONTROL DEVICE

(71) Applicant: TOYOTA JIDOSHA KABUSHIKI KAISHA, Toyota-shi (JP)

(72) Inventor: Jumpei INAGAKI, Toyota-shi (JP)

(73) Assignee: TOYOTA JIDOSHA KABUSHIKI KAISHA, Toyota-shi (JP)

(21) Appl. No.: 19/343,438

(22) Filed: Sep. 29, 2025

(30) Foreign Application Priority Data
Oct. 17, 2024 (JP) 2024-181945

(51) Int. Cl. B60K 35/81; B60K 35/10; B60K 35/28; B60K 35/65

(52) U.S. Cl. CPC B60K 35/81; B60K 35/10; B60K 35/28; B60K 35/654; B60K 2360/176; B60K 2360/741

(57) ABSTRACT

A display control device displays, inside a vehicle, a captured image of surroundings of the vehicle. The display control device includes an image acquisition unit that acquires a captured image including at least one of a side area and a rear area of the vehicle, a seating information acquisition unit that acquires seating information indicating presence or absence of an occupant in a passenger seat, a driving state acquisition unit that acquires driving state information of the vehicle, and a display control unit that, when the seating information indicates that an occupant is present in the passenger seat, controls a display position of the captured image inside the vehicle based on a driving state of the vehicle.

### CROSS-REFERENCE TO RELATED APPLICATIONS

This application is based upon and claims the benefit of priority from Japanese Patent Application No. 2024-181945, filed on October 17, 2024, the entire contents of which are incorporated herein by reference.

### TECHNICAL FIELD

### The present disclosure relates to a display control device

### BACKGROUND

For example, International Publication No. 2021/079975 describes a device that uses a left end portion and a right end portion of a display provided in a vehicle as a display unit of a digital outer mirror.

For example, an occupant in a passenger seat may check the surroundings of the vehicle by looking at a passenger-side outer mirror when getting out of the vehicle. In the device described above, an outer mirror is not mounted on the vehicle, and an image of a digital outer mirror is displayed on a display. However, depending on the installation position of the display, the visibility of the image of the digital outer mirror may be poor for the occupant in the passenger seat.

### SUMMARY

Accordingly, the present disclosure describes a display control device capable of improving visibility of a captured image of vehicle surroundings for an occupant in a passenger seat when the occupant in the passenger seat gets out of the vehicle.

A display control device of the present disclosure is [1] “a display

control device that displays, inside a vehicle, a captured image of surroundings of the vehicle, the display control device comprising: an image acquisition unit configured to acquire the captured image including at least one of a side area of the vehicle and a rear area of the vehicle; a seating information acquisition unit configured to acquire seating information indicating presence or absence of an occupant in a passenger seat of the vehicle; a driving state acquisition unit configured to acquire driving state information indicating a driving state of the vehicle; and a display control unit configured to, when the seating information indicates that the occupant is present in the passenger seat, control a display position of the captured image inside the vehicle based on the driving state of the vehicle indicated by the driving state information.”

The above display control device may be [2] “the display control device according to [1], wherein the driving state acquisition unit is configured to acquire, as the driving state information, shift information indicating a shift position of the vehicle, and wherein the display control unit is configured to: cause a first display unit provided in the vehicle to display the captured image, when the seating information indicates that the occupant is present in the passenger seat and the shift information indicates that the shift position is in a P range; and cause a second display unit, which is provided in the vehicle and is different from the first display unit, to display the captured image, when the seating information indicates that the occupant is present in the passenger seat and the shift information indicates that the shift position is not in the P range.”

The above display control device may be [3] “the display control device according to [2], wherein the display control unit is configured to cause the first display unit to display the captured image when the seating information indicates that the occupant is present in the passenger seat and when a seat belt of the passenger seat becomes an unfastened state after a state is reached in which the shift information indicates that the position of the shift position is in the P range.”

The above display control device may be [4] “the display control device according to [2] or [3], wherein the second display unit is provided in an instrument panel of the vehicle or is provided around the instrument panel, and wherein the first display unit is provided at a position closer to the passenger seat relative to the second display unit.”

The above display control device may be [5] “the display control device according to any one of [2] to [4], wherein the display control unit is configured to, after causing the first display unit to display the captured image, cause the second display unit to display the captured image when the seating information indicates that the occupant in the passenger seat has gotten out of the vehicle.”

According to one aspect of the present disclosure, it is possible to improve the visibility of a captured image of the vehicle surroundings for an occupant in the passenger seat when the occupant in the passenger seat gets out of the vehicle.

### BRIEF DESCRIPTION OF THE DRAWINGS

FIG. 1 is a block diagram illustrating an example of a display control device according to an embodiment.

FIG. 2 is a diagram illustrating arrangement positions of each display.

FIG. 3 is a flowchart illustrating a flow of display control processing performed by the display control device.

### DETAILED DESCRIPTION

Hereinafter, exemplary embodiments will be described with reference to the drawings. In the drawings, the same or corresponding elements are denoted by the same reference numerals, and redundant description thereof will be omitted.

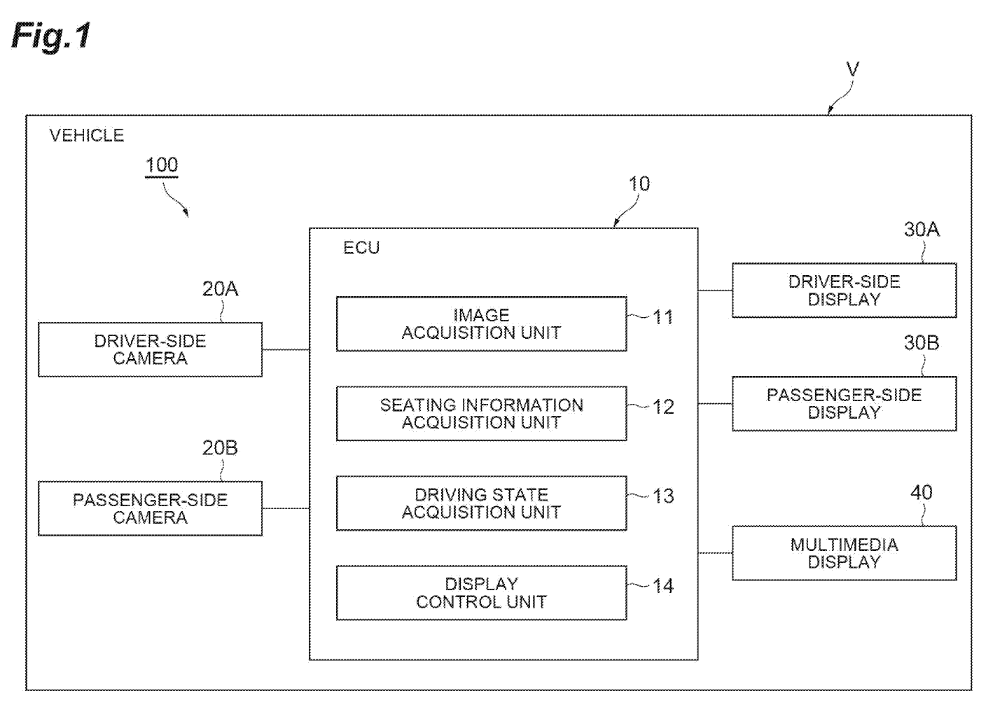

A display control device 100 illustrated in FIG. 1 is mounted on a vehicle V. The display control device 100 performs control to display a captured image of the surroundings of the vehicle V inside the vehicle V. The display control device 100 includes an electronic control unit (ECU) 10 that comprehensively manages the device.

The ECU 10 is an electronic control unit having a central processing unit (CPU) and a storage unit. The storage unit is configured by, for example, read only memory (ROM), random access memory (RAM), electrically erasable programmable read-only memory (EEPROM), or the like. In the ECU 10, for example, various functions are realized by a CPU executing a program stored in the storage unit. The ECU 10 may be configured by a plurality of electronic control units.

A driver-side camera 20A, a passenger-side camera 20B, a driver-side display 30A, a passenger-side display (second display unit) 30B, and a multimedia display (first display unit) 40 are connected to the ECU 10.

The driver-side camera 20A and the passenger-side camera 20B are each an imaging device that captures images of the surroundings of the vehicle V. The driver-side camera 20A can capture a range of at least one of a right side area and a rear area (right rear area) of the vehicle V. The driver-side camera 20A may be attached, for example, to the side surface (right side surface) on the driver’s seat side of the vehicle V. The passenger-side camera 20B can capture a range of at least one of a left side area and a rear area (left rear area) of the vehicle V. The passenger-side camera 20B may be attached, for example, to the side surface (left side surface) on the passenger seat side of the vehicle V. Captured images captured by the driver-side camera 20A and the passenger-side camera 20B, respectively, are input to the ECU 10.

The driver-side display 30A and the passenger-side display 30B are provided inside the vehicle V. The driver-side display 30A and the passenger-side display 30B are provided at positions visible to a driver of the vehicle V. The driver-side display 30A can display a captured image from the driver-side camera 20A. The passenger-side display 30B can display a captured image from the passenger-side camera 20B.

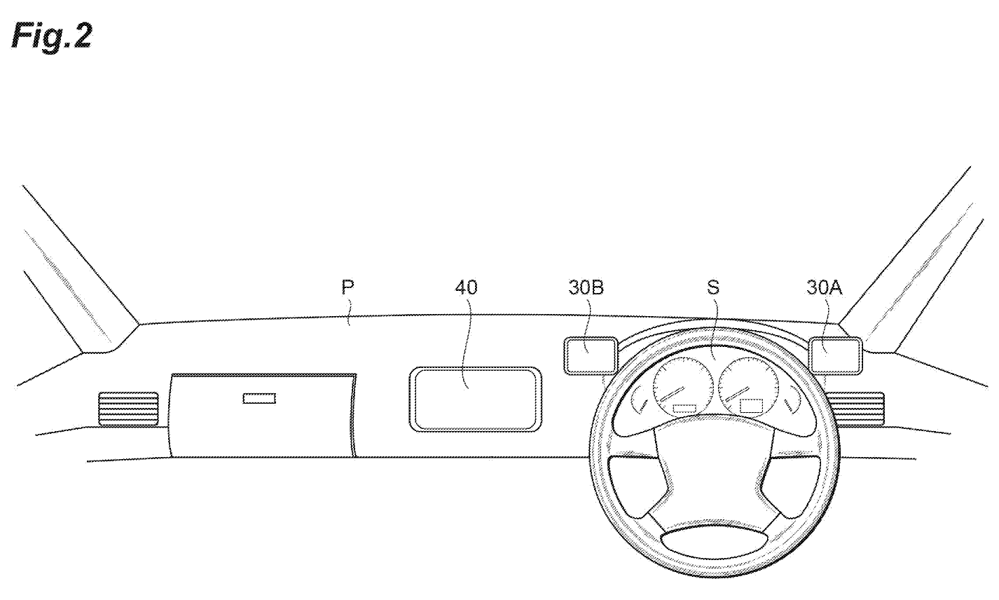

As illustrated in FIG. 2, in the present embodiment, the driver-side display 30A and the passenger-side display 30B are provided, as an example, around an instrument panel S provided in front of the driver’s seat. In the present embodiment, the driver-side display 30A is provided to the right of the instrument panel S as viewed from the driver. The passenger-side display 30B is provided to the left of the instrument panel S as viewed from the driver. Note that the driver-side display 30A and the passenger-side display 30B may be provided in the instrument panel S, instead of around the instrument panel S. In other words, the instrument panel S and the driver-side display 30A and the like may be integrated.

The multimedia display 40 is a device that presents various types of information to occupants of the vehicle V by display. The multimedia display 40 is provided at a position different from the passenger-side display 30B and the driver-side display 30A. The multimedia display 40 is visible not only to the driver of the vehicle V but also to an occupant in the passenger seat. The multimedia display 40 can display, for example, a route guidance screen of a navigation system, a music selection screen, and the like. In the present embodiment, the multimedia display 40 is provided, as an example, near the center (near the center in a vehicle width direction) of an instrument panel P provided in front of the driver’s seat and the passenger seat. Further, the multimedia display 40 is provided at a position on the passenger seat side of the passenger-side display 30B. In other words, the multimedia display 40 is provided at a position closer to the passenger seat than the passenger-side display 30B.

The ECU 10 functionally includes an image acquisition unit 11, a seating information acquisition unit 12, a driving state acquisition unit 13, and a display control unit 14. The image acquisition unit 11 acquires a captured image including at least one of a side area of the vehicle V and a rear area of the vehicle V. Here, the image acquisition unit 11 acquires captured images from the driver-side camera 20A and the passenger-side camera 20B.

The seating information acquisition unit 12 acquires seating information indicating presence or absence of an occupant in the passenger seat of the vehicle V. Here, as the seating information, various types of information can be used as long as it is information indicating the presence or absence of an occupant in the passenger seat. For example, the seating information may be seat belt information indicating whether the seat belt of the passenger seat is fastened or unfastened. The seat belt information may be, for example, information obtained based on a detection result of a sensor provided in a buckle portion of the seat belt (a sensor that detects whether a tongue plate (metal fitting) is fixed to the buckle), or the like. When the seat belt of the passenger seat is in a fastened state, it can be determined that an occupant is present in the passenger seat.

For example, the seating information may be image recognition information obtained based on a captured image from an occupant camera that captures an image of the vicinity of the passenger seat. The presence or absence of an occupant in the passenger seat can be recognized based on the captured image from the occupant camera, for example, based on a known image processing technique. The seating information acquisition unit 12 can acquire, for example, the image recognition information from an image processing unit that recognizes the presence or absence of an occupant. For example, the seating information may be pressure information obtained based on a detection result of a pressure sensor provided on a seat surface or a backrest of the passenger seat. For example, when pressure is detected by this pressure sensor, it can be determined that an occupant is present in the passenger seat. On the other hand, when pressure is not detected by this pressure sensor, it can be determined that no occupant is present in the passenger seat. The seating information may include open/close information of a passenger-side door. The seating information may include one or more of these pieces of information.

The driving state acquisition unit 13 acquires driving state information indicating a driving state of the vehicle V. In the present embodiment, the driving state acquisition unit 13 acquires, as the driving state information, shift information indicating a shift position of the vehicle V. This shift information includes information indicating whether the shift position of the vehicle V is in a P range (a range for parking and stopping) or in another range. For example, when the position of the shift position is in the P range, the driving state of the vehicle V can be said to be a parked or stopped state. When the position of the shift position is in a range other than the P range, the driving state of the vehicle V can be said to be a running state (a state of running or being in a momentary stop at a red light or the like).

The display control unit 14 controls display positions of respective captured images captured by the driver-side camera 20A and the passenger-side camera 20B. In the present embodiment, the display control unit 14 causes the driver-side display 30A to display the captured image from the driver-side camera 20A. The display control unit 14 causes the passenger-side display 30B or the multimedia display 40 to display the captured image from the passenger-side camera 20B. Hereinafter, details of processing for causing the passenger-side display 30B or the multimedia display 40 to display the captured image from the passenger-side camera 20B will be described.

The display control unit 14 uses the seating information acquired by the seating information acquisition unit 12 and the driving state information acquired by the driving state acquisition unit 13 to control the display position inside the vehicle V of the captured image from the passenger-side camera 20B acquired by the image acquisition unit 11. Here, when the seating information indicates that an occupant is present in the passenger seat, the display control unit 14 causes the passenger-side display 30B or the multimedia display 40 to display the captured image from the passenger-side camera 20B based on the driving state of the vehicle V indicated by the driving state information.

Specifically, there is a case where the seating information indicates that an occupant is present in the passenger seat, and the shift information indicates that the shift position is in the P range. In this case, the display control unit 14 causes the multimedia display 40 to display the captured image from the passenger-side camera 20B. In other words, when the vehicle V is in a parked or stopped state, the display control unit 14 causes the multimedia display 40 to display the captured image from the passenger-side camera 20B so that the captured image from the passenger-side camera 20B is also easy for the occupant in the passenger seat to see.

Further, there is a case where the seating information indicates that an occupant is present in the passenger seat, and the shift information indicates that the shift position is not in the P range. In this case, the display control unit 14 causes the passenger-side display 30B to display the captured image from the passenger-side camera 20B. In other words, when the vehicle V is in a running state, the display control unit 14 causes the passenger-side display 30B to display the captured image from the passenger-side camera 20B so that the driver can easily see the captured image from the passenger-side camera 20B.

Note that when causing the multimedia display 40 to display the captured image from the passenger-side camera 20B, the display control unit 14 may perform display control based on the seat belt information. Specifically, the display control unit 14 may cause the multimedia display 40 to display the captured image from the passenger-side camera 20B when the seating information indicates that an occupant is present in the passenger seat and when the seat belt of the passenger seat becomes an unfastened state after a state is reached in which the shift information indicates that the position of the shift position is in the P range.

In other words, the display control unit 14 determines whether the seat belt of the passenger seat has become an unfastened state based on the seat belt information included in the seating information. If an occupant unfastens the seat belt while the vehicle V is parked or stopped, it is considered highly likely that the occupant will get out of the vehicle. For this reason, the display control unit 14 can determine the possibility that the occupant in the passenger seat will get out of the vehicle, based on the seat belt information. Then, when the occupant in the passenger seat unfastens the seat belt and it is highly likely that the occupant gets out of the vehicle, the display control unit 14 causes the multimedia display 40 to display the captured image from the passenger-side camera 20B so that the occupant in the passenger seat who gets out of the vehicle can easily view the captured image. In this case, the display control device 100 can more appropriately determine whether the occupant in the passenger seat will get out of the vehicle by using the seat belt information. Then, the display control device 100 can more appropriately switch the display position of the captured image from the passenger-side camera 20B based on this determination result.

Further, after causing the multimedia display 40 to display the captured image from the passenger-side camera 20B, the display control unit 14 causes the passenger-side display 30B to display the captured image from the passenger-side camera 20B when the seating information indicates that the occupant in the passenger seat has gotten out of the vehicle.

For example, the display control unit 14 may determine that it is indicated that the occupant in the passenger seat has gotten out of the vehicle when the occupant in the passenger seat is no longer recognized, based on the image recognition information. For example, the display control unit 14 may determine that it is indicated that the occupant in the passenger seat has gotten out of the vehicle when the pressure sensor provided in the passenger seat no longer detects pressure, based on the pressure information. For example, the display control unit 14 may determine that it is indicated that the occupant in the passenger seat has gotten out of the vehicle when the seat belt is unfastened and the door is opened and closed, based on the seat belt information and the door open/close information. In addition to these, the display control unit 14 can determine whether the seating information indicates that the occupant in the passenger seat has gotten out of the vehicle, based on one or more pieces of information included in the seating information.

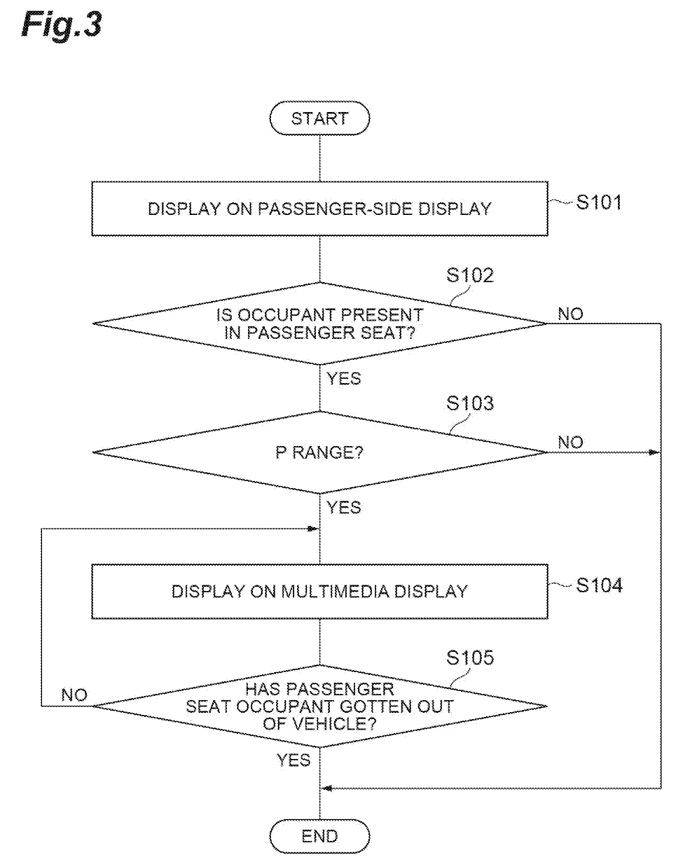

Next, a flow of display control processing performed by the display control device 100 will be described with reference to the flowchart of FIG. 3. Here, the display control processing for when the display control device 100 displays the captured image from the passenger-side camera 20B on the passenger-side display 30B or the multimedia display 40 will be described. In the processing illustrated in FIG. 3, when the processing reaches an end, the processing is started from a start after a predetermined time.

As illustrated in FIG. 3, the display control unit 14 causes the passenger-side display 30B to display the captured image from the passenger-side camera 20B (S101). The display control unit 14 determines whether the seating information indicates that an occupant is present in the passenger seat (S102). If no occupant is present in the passenger seat (S102: NO), the processing proceeds to the end. If an occupant is present in the passenger seat (S102: YES), the display control unit 14 determines whether the shift position is in the P range based on the shift information acquired by the driving state acquisition unit 13 (S103). If the shift position is not in the P range (S103: NO), the processing proceeds to the end.

If the shift position is in the P range (S103: YES), the display control unit 14 displays the captured image from the passenger-side camera 20B on the multimedia display 40 (S104). The display control unit 14 determines whether the occupant in the passenger seat has gotten out of the vehicle based on the seating information (S105). If the occupant in the passenger seat has not gotten out of the vehicle (S105: NO), the display control unit 14 performs the processing of step S104. If the occupant in the passenger seat has gotten out of the vehicle (S105: YES), the processing proceeds to the end. As a result, the captured image from the passenger-side camera 20B is displayed on the passenger-side display 30B (S101).

Note that, as described above, when causing the multimedia display 40 to display the captured image from the passenger-side camera 20B, the display control unit 14 may perform display control based on the seat belt information. In this case, after determining in the processing of step S103 that the shift position is in the P range, the display control unit 14 determines whether the seat belt of the passenger seat has become an unfastened state. Then, when the seat belt of the passenger seat has become an unfastened state, the display control unit 14 may cause the multimedia display 40 to display the captured image from the passenger-side camera 20B by the processing of step S104.

As described above, when the seating information indicates that an occupant is present in the passenger seat, the display control unit 14 controls the display position inside the vehicle V of the captured image from the passenger-side camera 20B based on the driving state of the vehicle V indicated by the driving state information. As a result, the display control device 100 can improve the visibility of the captured image of the surroundings of the vehicle V for the occupant in the passenger seat when the occupant in the passenger seat gets out of the vehicle.

More specifically, when the seating information indicates that an occupant is present in the passenger seat and the shift information (driving state information) indicates that the shift position is in the P range, the display control unit 14 causes the multimedia display 40 to display the captured image from the passenger-side camera 20B. Further, when the seating information indicates that an occupant is present in the passenger seat and the shift information indicates that the shift position is not in the P range, the display control unit 14 causes the passenger-side display 30B, which is different from the multimedia display 40, to display the captured image from the passenger-side camera 20B. In this way, the display control unit 14 can change the display position of the captured image from the passenger-side camera 20B based on the presence or absence of an occupant in the passenger seat and the shift information. Note that the multimedia display 40 is provided at a position that is easily visible also to the occupant in the passenger seat. As a result, the display control device 100 can improve the visibility of the captured image from the passenger-side camera 20B for the occupant in the passenger seat when the occupant in the passenger seat gets out of the vehicle.

The passenger-side display 30B is provided in the instrument panel S or is provided around the instrument panel S. The multimedia display 40 is provided at a position closer to the passenger seat side than the passenger-side display 30B. As a result, when the occupant in the passenger seat gets out of the vehicle, the display control device 100 can display the captured image from the passenger-side camera 20B on the multimedia display 40, which is more easily viewed by the occupant in the passenger seat than the passenger-side display 30B. As a result, the display control device 100 can improve the visibility of the captured image from the passenger-side camera 20B for the occupant in the passenger seat.

After causing the multimedia display 40 to display the captured image from the passenger-side camera 20B, the display control unit 14 causes the passenger-side display 30B to display the captured image from the passenger-side camera 20B when the occupant in the passenger seat has gotten out of the vehicle. This allows the driver of the vehicle V to easily view the captured image from the passenger-side camera 20B.

What is claimed is:

1. A display control device that displays, inside a vehicle, a captured image of surroundings of the vehicle, the display control device comprising:
an image acquisition unit configured to acquire the captured image including at least one of a side area of the vehicle and a rear area of the vehicle;
a seating information acquisition unit configured to acquire seating information indicating presence or absence of an occupant in a passenger seat of the vehicle;
a driving state acquisition unit configured to acquire driving state information indicating a driving state of the vehicle; and
a display control unit configured to, when the seating information indicates that the occupant is present in the passenger seat, control a display position of the captured image inside the vehicle based on the driving state of the vehicle indicated by the driving state information.

2. The display control device according to claim 1, wherein
the driving state acquisition unit is configured to acquire, as the driving state information, shift information indicating a shift position of the vehicle, and
wherein the display control unit is configured to:
cause a first display unit provided in the vehicle to display the captured image, when the seating information indicates that
the occupant is present in the passenger seat and the shift information indicates that the shift position is in a P range; and
cause a second display unit, which is provided in the vehicle and is different from the first display unit, to display the captured image, when the seating information indicates that the occupant is present in the passenger seat and the shift information indicates that the shift position is not in the P range.

3. The display control device according to claim 2, wherein
the display control unit is configured to cause the first display unit to display the captured image when the seating information indicates that the occupant is present in the passenger seat and when a seat belt of the passenger seat becomes an unfastened state after a state is reached in which the shift information indicates that the position of the shift position is in the P range.

4. The display control device according to claim 2, wherein
the second display unit is provided in an instrument panel of the vehicle or is provided around the instrument panel, and
wherein the first display unit is provided at a position closer to the passenger seat relative to the second display unit.

5. The display control device according to claim 2, wherein
the display control unit is configured to, after causing the first display unit to display the captured image, cause the second display unit to display the captured image when the seating information indicates that
the occupant in the passenger seat has gotten out of the vehicle.
